(19) United States
(12) Patent Application Publication
(10) Pub. No.: US 2006/0154700 A1
(43) Pub. Date: Jul. 13, 2006

(54) Input device using transparent keypad

(75) Inventor: Jef Raskin, Pacifica, CA (US)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/319,978

(22) Filed: Dec. 28, 2005

Related U.S. Application Data
(60) Provisional application No. 60/642,543, filed on Jan. 10, 2005.

(30) Foreign Application Priority Data
Sep. 27, 2005 (KR) 89951/2005

(51) Int. Cl. H04M 1/00

(52) U.S. Cl. 455/575.1; 455/566

(57) ABSTRACT

Disclosed is an input device for a portable terminal. The input device includes a transparent keypad which is provided on a rear side thereof with input sections of a plurality of keys, and an input signal processing unit for generating an input signal corresponding to the key selected by a user from among the plurality of keys and processing the generated signal. A portable terminal with such a input device further includes a display unit for displaying a result of input signal processing in the input signal processing unit.

### PRIORITY

This application claims priority to a provisional application entitled “TRANSPARENT KEYBOARD” filed with the United States Patent and Trademark Office on Jan. 10, 2005 and assigned Ser. No. 60/642,543 and to an application entitled “Input Device Using Transparent Keypad” filed in the Korean Industrial Property Office on Sep. 27, 2005, and assigned Serial No. 2005-89951, the contents of which are hereby incorporated by reference.

### BACKGROUND OF THE INVENTION

1. Field of the Invention

The present invention relates to an input device, and more particularly to an input device employing a transparent keypad which can be used in a portable terminal.

2. Description of the Related Art

Portable terminals have recently become more and more complex, and provide not only voice communication, but also a variety of other functions such as message sending, schedule management, Internet access, games and so forth. For using such functions, portable terminals are provided with character input means.

FIG. 1 illustrates the conventional character input means of a portable terminal. A user holds the portable terminal in one hand or in both hands, and inputs characters by using a keypad located on the front side of the portable terminal. At this time, since only the user's thumb is positioned on the front side of the portable terminal while the other fingers are positioned on the rear side of the portable terminal, the user usually uses only the thumb for inputting characters. However, using only one finger in this way is problematic in that character input speed is slow as compared with input via a common computer keyboard.

### SUMMARY OF THE INVENTION

Accordingly, the present invention has been made to solve at least the above-mentioned problem occurring in the prior art, and an object of the present invention is to provide an input device for a portable terminal, which enables a user to use a plurality of fingers for inputting characters.

To accomplish this object, in accordance with one aspect of the present invention, there is provided a transparent keypad with key input sections which are located on the rear side of a portable terminal and through which characters can be inputted into the portable terminal.

In accordance with another aspect of the present invention, there is provided a portable terminal including a transparent keypad mounted thereto and enabling a user to input characters by using a plurality of fingers.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating the conventional character input means of a portable terminal;

FIG. 2 is a front view of an input device in accordance with a preferred embodiment of the present invention;

FIG. 3 is a perspective view of the input device in accordance with the preferred embodiment of the present invention;

FIG. 4 is a rear view of the input device in accordance with the preferred embodiment of the present invention; and

FIG. 5 is a block diagram illustrating an internal structure of a portable terminal in accordance with a preferred embodiment of the present invention.

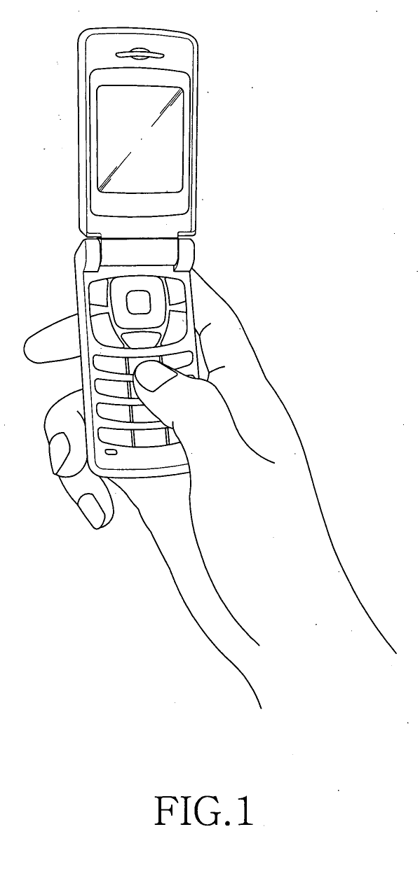

### DETAILED DESCRIPTION OF THE PREFERRED EMBODIMENT

Hereinafter, a preferred embodiment of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention supports speedy character typing using almost all of a user's fingers. To this end, the present invention uses a transparent keypad that facilitates speedy character typing by the user. In this way, the user can emerge from a character input scheme restrictively using only one or two fingers, and can input desired characters by seeing fingers of both hands through the transparent keypad and moving the fingers to operate keys of the transparent keypad.

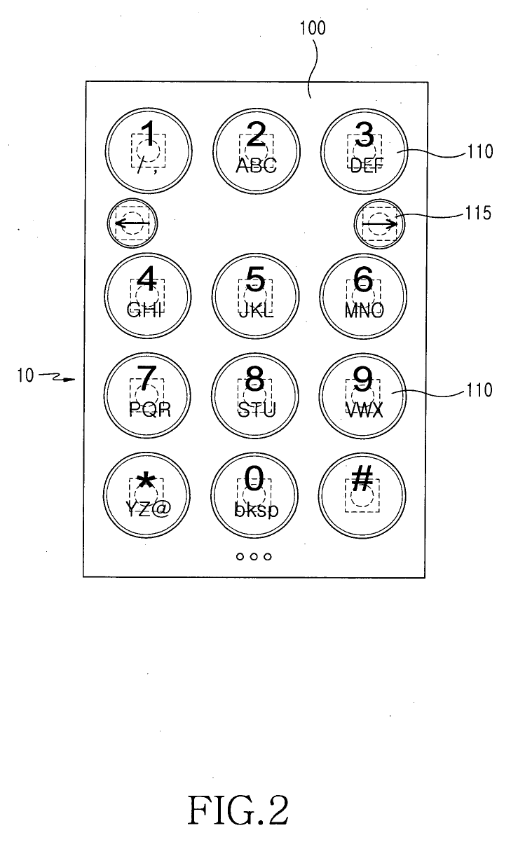

Hereinafter, a description will be given for components taking charge of character input through a transparent keypad. Such components will be described with reference to FIGS. 2 to 4.

FIG. 2 illustrates an input device in accordance with a preferred embodiment of the present invention, as seen from the front.

The input device 10 includes a transparent keypad 100 and a plurality of keys 110 for inputting a plurality of letters and numerals, which are located on the rear side of the keypad 100. In addition, the input device 10 may include a navigation key or special function buttons.

Although this embodiment shows that a series of English alphabets and a corresponding numeral are disposed on the respective keys 110, it is obvious that other letters and symbols such as Korean alphabets, etc. may be disposed in addition to the English alphabets. Of the keys 110, a leap function key 115, designated by an arrow, functions to perform word-by-word leaping and moving to the beginning or end of a sentence during character edition. That is, if the leap function key 115 is pushed down for a short time, a cursor leaps over words one by one, and if the leap function key 115 is pushed down for a long time, the cursor moves to the beginning or end of a sentence.

Although not shown in the drawing, the input device 10 also includes a signal processing unit for processing signals inputted through the keys 110.

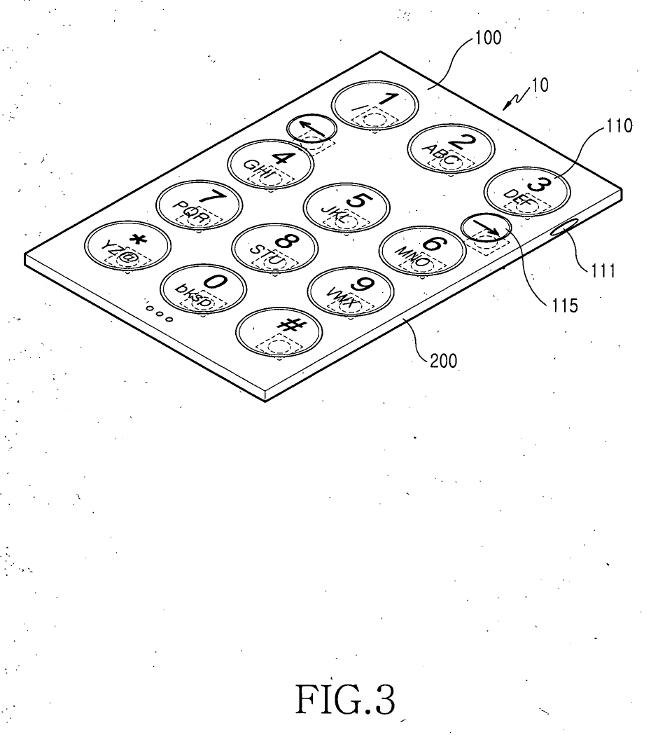

FIG. 3 illustrates the input device according to the preferred embodiment of the present invention in a perspective view.

Besides the keypad 100 and the keys 110, the input device 10 includes an additional input unit 111 located on one side of the input device 10. The additional input unit 111 can carry out a variety of functions such as direction adjustment of a displayed image, volume adjustment during a voice call, and the like. The additional input unit 111 for performing such functions may be located at positions other than the right or left side of the transparent keypad.

Also, the additional input unit 111 may be used for selecting a letter desired to be inputted from among a series of letters disposed on one key 110.

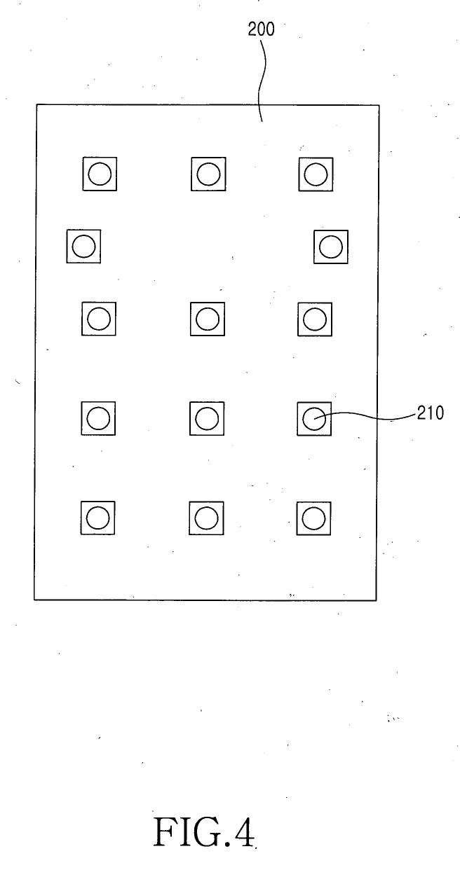

FIG. 4 illustrates the rear side 200 of the input device according to the preferred embodiment of the present invention.

As stated above, actual input sections 210 of the keys 110 are located on the rear side of the keypad 100. Each input section 210 on the rear side of the keypad 100 may be realized in any form including a mechanically-pressed button, a touch sensor, etc. Thus, a user can press or touch the respective input sections 210 on the rear side of the keypad 100 to input data corresponding to the keys. The input sections 210 are connected to the signal processing unit for processing the input data.

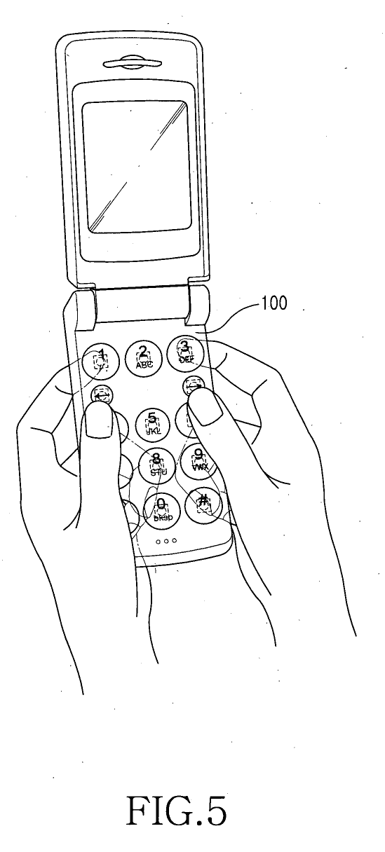

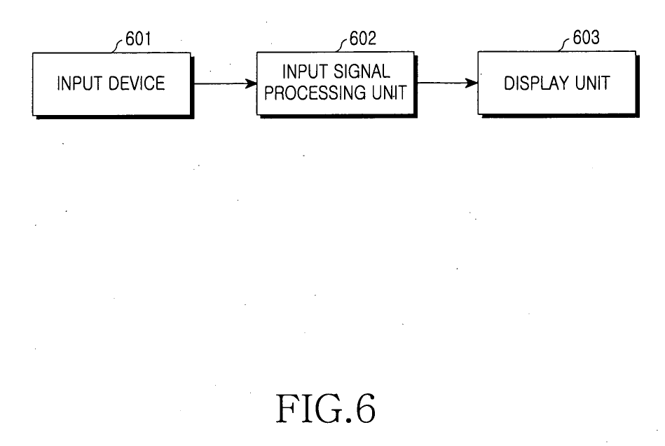

FIG. 5 illustrates a situation in which a user holds a portable terminal, including the transparent keypad proposed in the present invention, in both hands, and inputs characters into the portable terminal.

Dissimilarly to the existing character input scheme in which only a user's thumb is used for character input, the user can carry out more speedy and efficient character input operations by using fingers of both hands. As seen from the drawing, the user's fingers are placed on the rear side of the transparent keypad 100, and the user can recognize a corresponding letter, which the user desires to input, through empty spaces between the keys of the transparent keypad 100. The user laterally balances the portable terminal on the thumbs of both hands, and inputs characters through mechanical buttons or touch sensors on the rear side of the input device. In another example, the user may support the front and rear sides of the transparent keypad 100 by the thumbs or index fingers of both hands to balance the portable terminal, and then carry out character input operations. In this input scheme, from moment to moment, a centre of the portable terminal to balance by user's fingers may be altered to the right or left of the input device at the user's pleasure. Also, the fingers for balancing the portable terminal may be selected in a manner comfortable to the user if desired, and the user may occasionally use the lateral additional input unit 111.

FIG. 6 illustrates an internal structure of a portable terminal in accordance with a preferred embodiment of the present invention.

The portable terminal according to this embodiment includes an input device 601 for inputting letters, numerals and other symbols selected by a user, an input signal processing unit 602 for generating signals of input data and processing the generated signals, and a display unit 603 for displaying the processed input signals on a LCD window, etc., so as to enable the user to confirm the input signals.

The transparent keypad of the present invention may be applied to mobile terminals, PDAs or any other devices necessary for character input.

A user may apply the transparent keypad of the present invention to game operations.

As described above, according to the present invention, a user can emerge from the existing character input scheme in which only the user's thumb is used for character input, and freely use all fingers of both hands through a transparent keypad, resulting in more speedy and exact character input.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An input device for a portable terminal, the device comprising:
a transparent keypad including input sections of a plurality of keys on a rear side thereof; and
an input signal processing unit for generating an input signal corresponding to the key selected by a user from among the plurality of keys and processing the generated signal.

2. The device as claimed in claim 1, wherein at least one of letters, numerals and/or other symbols are disposed on the plurality of keys.

3. The device as claimed in claim 2, wherein a function key for word-by-word leaping and moving to the beginning or end of a sentence during character edition is further included in the plurality of keys.

4. The device as claimed in claim 1, further comprising an additional input unit for adjusting directions of displayed images and characters or performing other preset functions.

5. The device as claimed in claim 1, wherein the input sections of the plurality of keys are formed as a mechanical button or a touch sensor.

6. A portable terminal comprising:
a transparent keypad including input sections of a plurality of keys on a rear side thereof;
an input signal processing unit for generating an input signal corresponding to the key selected by a user from among the plurality of keys and processing the generated signals; and
a display unit for displaying results of the input signal processing in the input signal processing unit.

7. The portable terminal as claimed in claim 6, wherein at least one of letters, numerals and/or other symbols are disposed on the plurality of keys.

8. The portable terminal as claimed in claim 7, wherein a function key for word-by-word leaping and moving to the beginning or end of a sentence during character edition is further included in the plurality of keys.

9. The portable terminal as claimed in claim 6, wherein the input sections of the plurality of keys are formed as a mechanical button or a touch sensor.
